(19) United States
(12) Patent Application Publication
(10) Pub. No.: US 2012/0231201 A1
(43) Pub. Date: Sep. 13, 2012

(54) PROFILE ELEMENT AND METHOD FOR MANUFACTURING A PROFILE ELEMENT

(75) Inventor: Christof Maisch, Gaggenau (DE)

(73) Assignee: Protektorwerk Florenz Maisch GmbH & Co. KG, Gaggenau (DE)

(21) Appl. No.: 13/497,603

(22) PCT Filed: Sep. 10, 2010
(86) PCT No.: PCT/EP10/05834

§ 371 Date: May 31, 2012

(30) Foreign Application Priority Data
Oct. 1, 2009 (DE) 102009047958.9

(51) Int. Cl. B32B 3/06; B32B 3/24; B23P 17/04; B32B 7/08

(52) U.S. Cl. 428/57; 29/428

(57) ABSTRACT

A profile element (1) is described, in particular a construction profile, for example, a dry construction profile, a profile for facades or a rendering profile, a screed profile, a tiling profile or cable support profile, having an elongate profile body (2), in particular consisting of metal or plastics material, in which a plurality of openings are formed. The profile body (2) comprises at least two separately formed longitudinal portions (10, 11), each of which comprises a meandering longitudinal edge (12, 13). The longitudinal portions (10, 11) have overlapping regions (28, 29), which are bounded in some regions by the meandering longitudinal edges (12, 13). Connecting means (16, 17; 30, 31; 37, 40) formed in the overlapping regions (28, 29) are used to plug together the longitudinal portions (10, 11) in a direction transverse to the longitudinal extension thereof. The openings (5) are formed between portions (24, 25) of the meandering longitudinal edges (12, 13) of the two longitudinal portions (10, 11). Furthermore, a method is described for manufacturing a corresponding profile element (1).

The present invention relates to a section element, in particular to a structural section, for example a dry construction section, a section for the face of a building, a plaster section, a screed section, a tile section or a cable carrier section or a frame rail or drainage rail, having an elongated section body which is in particular metal or comprises plastic and in which a plurality of openings are formed. The invention is furthermore directed to a method for manufacturing such a section element.

Section elements of this type are used, for example, as C-shaped upright sections for dry construction, wherein the openings provided in the section body of the section element can serve, for example, as leadthrough openings for cables, lines or other elongated band-shaped or rope-shaped elements as well as pipes or other hollow bodies. These openings can furthermore also serve for ventilation or allow the passing through of filler materials such as insulating material, for example.

In known section elements, these openings are introduced by a punching procedure, for example. It is disadvantageous in this that the punched out material forms waste, whereby the manufacturing costs for such section elements are increased.

It is an object of the present invention to provide a section element of the initially named kind which can be manufactured in a simple and inexpensive manner and with reduced material effort. Furthermore, a method for manufacturing such a section element should be provided.

Starting from a section element of the initially named kind, the object relating to the section element is satisfied in that the section body includes at least two separately formed longitudinal portions, in that each longitudinal portion includes a meandering longitudinal edge, in that the longitudinal portions have mutually overlapping regions which are regionally bounded by the meandering longitudinal edges, in that connection means are formed in the overlapping regions via which the longitudinal portions are plugged together in a direction transverse to their longitudinal extent, and in that the openings are formed between portions of the meandering longitudinal edges of the two longitudinal portions.

The part of the object relating to the method is satisfied in accordance with the invention starting from a method of the initially named kind in that two separate longitudinal portions each having a meandering longitudinal edge are provided to produce the section body, wherein the longitudinal portions have regions which are regionally bounded by the meandering longitudinal edges, in that connection means are formed in the regions for plugging the longitudinal portions together, and in that the longitudinal portions are moved apart transverse to their longitudinal extent so that the regions of the two longitudinal portions overlap, the longitudinal portions are plugged together via the connection means and the openings are formed between portions of the meandering longitudinal edges of the two longitudinal portions.

In accordance with the invention, no waste is thus generated for the production of the openings of the section body so that material can be saved with respect to a production by punching out, for example. In other words, a wider design of the section element is achieved with the same quantity of material by the moving apart of two separately formed longitudinal portions. Regions of the longitudinal portions are produced by the meandering longitudinal edges which overlap after the moving apart, with connection means being formed in these regions. The manufacture of the section element made in accordance with the invention can thus be carried out very simply since, despite the originally separate formation of the two longitudinal portions, they are automatically connected to one another again on the moving apart in that the longitudinal portions are plugged together on the moving apart. In this respect, the term “transverse” is to be understood as any direction which does not extend only in the longitudinal direction of the section element or its longitudinal portions. The term “transverse” can thus in particular mean perpendicular or also oblique to the longitudinal extent of the section element or of the longitudinal portions.

The connection means can preferably be made in one piece with the longitudinal portions. It is, however, also conceivable that the connection means are made as separate components which are fastened to the overlapping regions of the longitudinal portions.

In accordance with a preferred embodiment of the invention, slits which extend transverse to the longitudinal direction of the respective longitudinal portion extend into the overlapping regions of the longitudinal portions, starting in each case from the meandering longitudinal edge, with the longitudinal portions being plugged together by means of the slits. The connection means are thus formed by simple slits in this embodiment, which enables a very simple and inexpensive manufacturing process.

Alternatively or additionally, locking tabs can advantageously be formed in the overlapping regions of one or both longitudinal portions, said locking tabs projecting into locking openings formed in the overlapping regions of the respective other longitudinal portion. The locking tabs can in this respect, for example, be shaped directly from the material of the longitudinal portions. A very simple and inexpensive design of the connection means in the form of locking tabs and locking openings is also possible in this embodiment.

Each longitudinal portion advantageously includes a plurality of portions, in particular T-shaped or bar-shaped portions, which are bounded by the meandering longitudinal edges and protrude from a region of the respective longitudinal portion in particular made as a straight-line longitudinal strip. The named overlapping regions, which project transverse to the longitudinal extent of the longitudinal portions with respect to the mutually adjoining longitudinal regions of the longitudinal portions, are formed by the in particular bar-shaped portions or by the crossbars of corresponding T-shaped portions. In a design as T-shaped portions, the overlapping regions furthermore project in the longitudinal direction with respect to the middle bars of the T-shaped portions in the longitudinal direction of the longitudinal portions.

The connection means are preferably made as latch connection means. Not only the moving apart of the longitudinal portions is thereby limited, but also an opposite movement to release the plug-in connection is prevented after a complete plugging together.

In accordance with a further advantageous embodiment of the invention, the longitudinal portions are connected to one another by further connection means in addition to the plug-in connection via the connection means. The longitudinal portions can thus, for example, additionally be connected to one another by a pressure joining process such as clinching or crimping, by clamping, pinching, pressing, welding, screwing, adhesive bonding or riveting or by any other suitable connection process. This additional connection can in this respect in particular be provided in the overlapping regions as well as, optionally in additional regions of the longitudinal portions.

The separate longitudinal portions can already be originally manufactured from separate material portions. They can, for example, have the same or different material thicknesses and can also comprise the same or different materials.

The separate longitudinal portions can advantageously be manufactured from an originally uniform material portion. In this case, at least one meandering slit which extends in the longitudinal extent of the starting material and by which the starting material is divided into two separate longitudinal portions can be introduced into an elongate strip-shaped starting material.

In both cases, the plug-in connection between the two longitudinal portions can be achieved by a corresponding moving apart of the longitudinal portions. Whereas the two longitudinal portions can already be arranged in their starting position for the moving apart after introduction of the meandering slit in the manufacture from an originally one-piece starting material, in the manufacture from two different material portions the two longitudinal portions can initially be brought into a corresponding starting position with respect to one another in which, for example, edge portions of the meandering longitudinal edges of the two longitudinal portions form undercuts in a direction transverse to the longitudinal extent of the section element or of the longitudinal portions. In both cases, the desired plug-in connection can be automatically achieved by the moving apart of the longitudinal portions in a direction transverse to its longitudinal extent since the corresponding connection means are automatically brought into engagement during the overlapping of the regions of the two longitudinal portions on the moving apart. In addition, it is ensured by the connection means that the longitudinal portions cannot be completely moved apart, but the movement is rather limited by mutually contacting edges of the connection means after a complete plugging together of the longitudinal portions.

It is also possible that the longitudinal portions are mutually displaced substantially in the longitudinal direction prior to the moving apart of the longitudinal portions transverse to their longitudinal extent to achieve a desired starting position for the moving apart. The starting position is in this respect advantageously selected so that, on the subsequent moving apart of the longitudinal portions, the regions to overlap move into overlap so that the connection means engage into one another.

The regions of the longitudinal portions to overlap are advantageously set upward regionally, for example bent upward, prior to the moving apart. It is thereby ensured that the provided connection means actually engage into one another and the two longitudinal portions cannot be moved apart without mutual engagement of the connection means.

Further advantageous embodiments of the invention are set forth in the dependent claims.

The invention will be described in more detail in the following with reference to embodiments and to the drawings; there are shown in these:

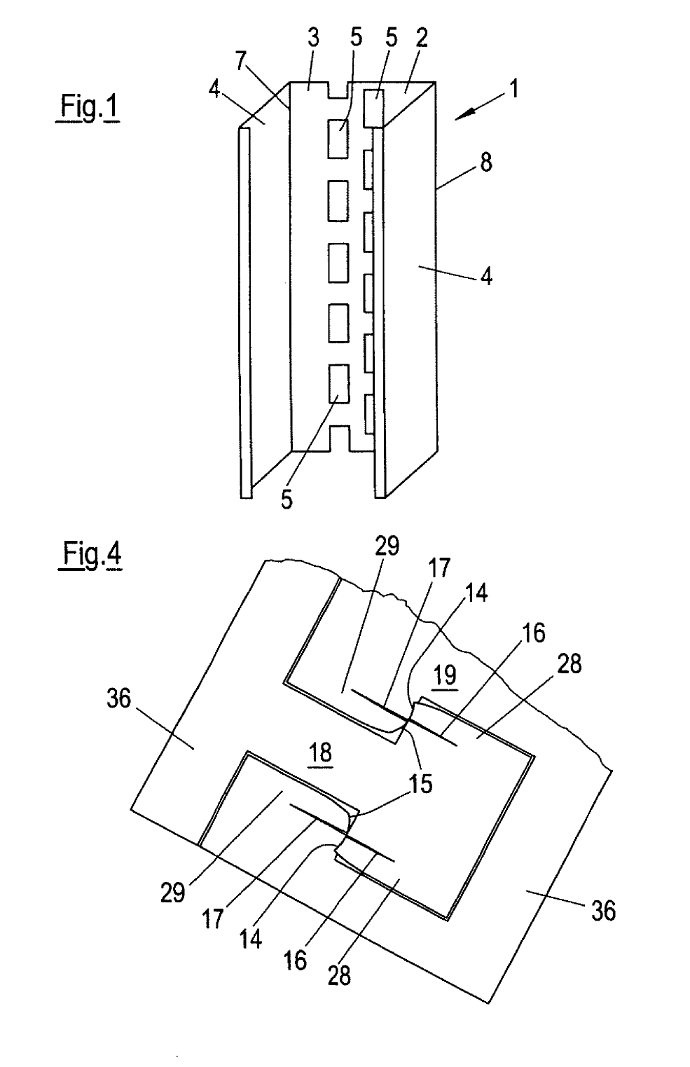

FIG. 1a schematic perspective representation of a section element made in accordance with the invention;

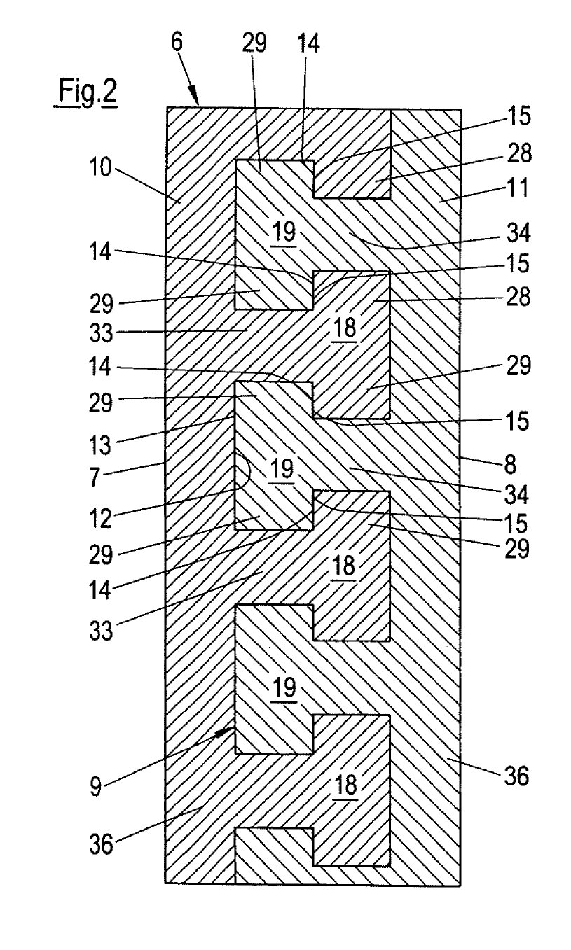

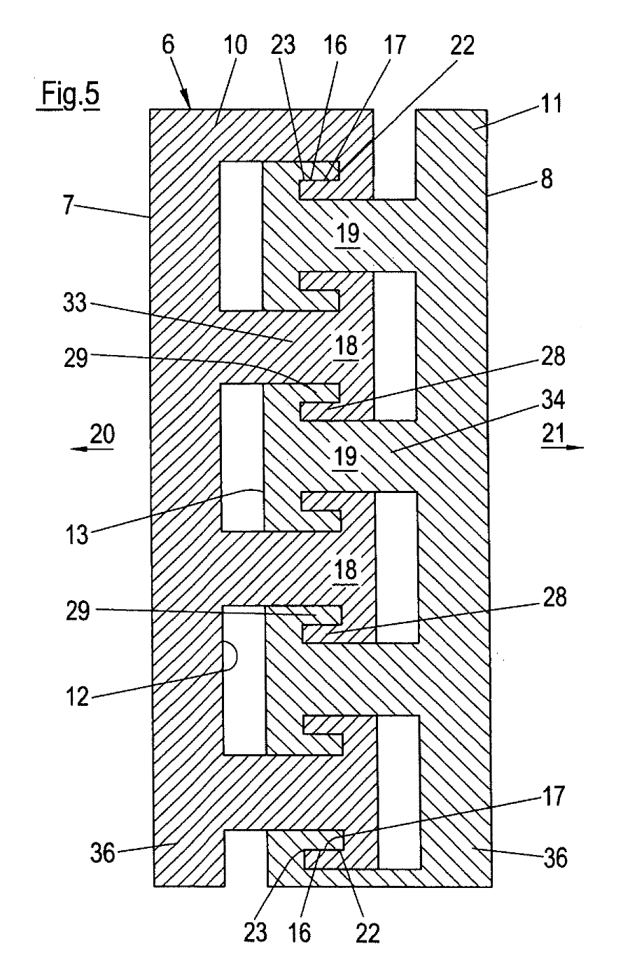

FIGS. 2 to 7 different intermediate steps in the manufacture of a section element of FIG. 1 made In accordance with the invention;

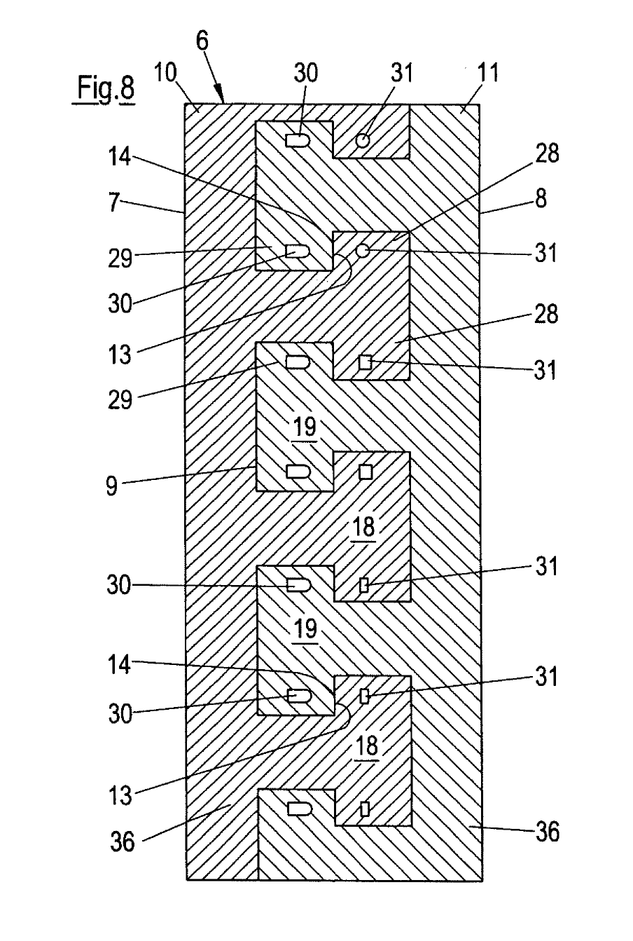

FIG. 8 an intermediate state of a material portion for the formation of a second section element made In accordance with the invention;

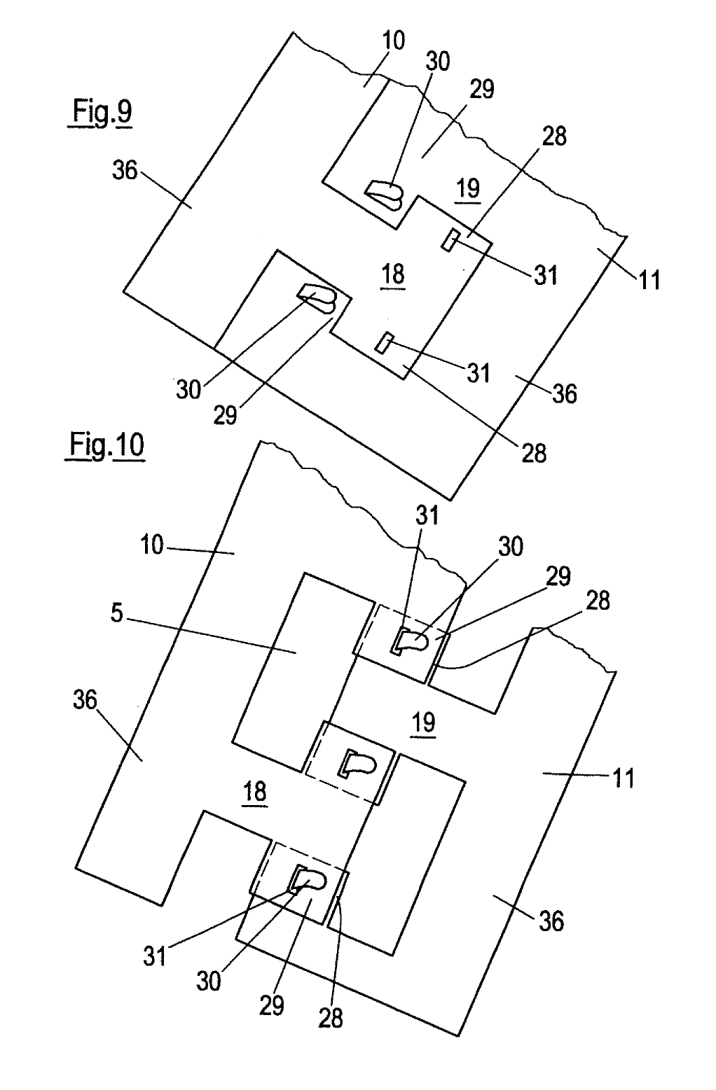

FIG. 9 a perspective detailed view of the representation of FIG. 8;

FIG. 10 a perspective detailed view of the second section element in a second intermediate step of the manufacture;

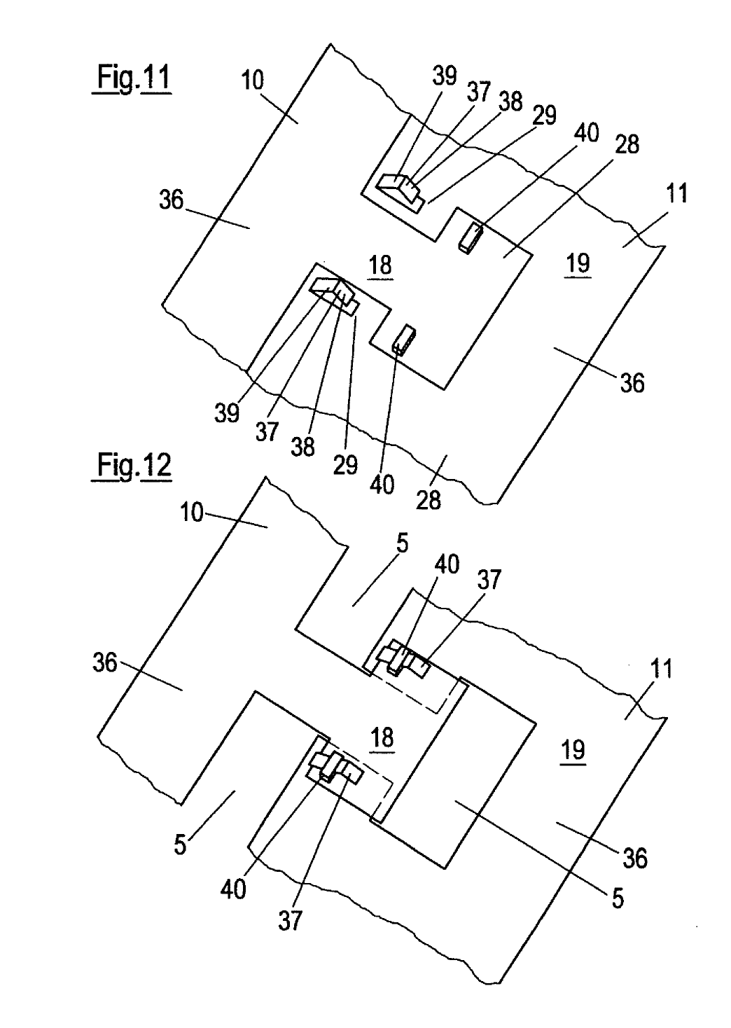

FIG. 11 a further embodiment of the invention;

FIG. 12 the embodiment of FIG. 11 in a plugged together state;

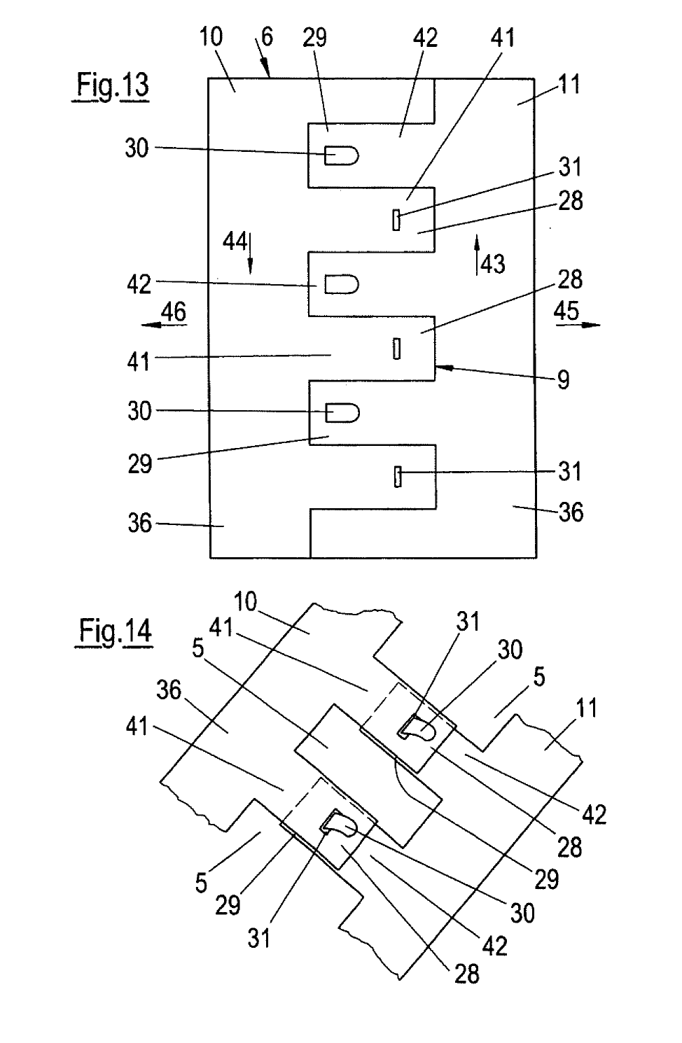

FIG. 13 a further embodiment of the invention;

FIG. 14 the embodiment of FIG. 13 in a plugged together state;

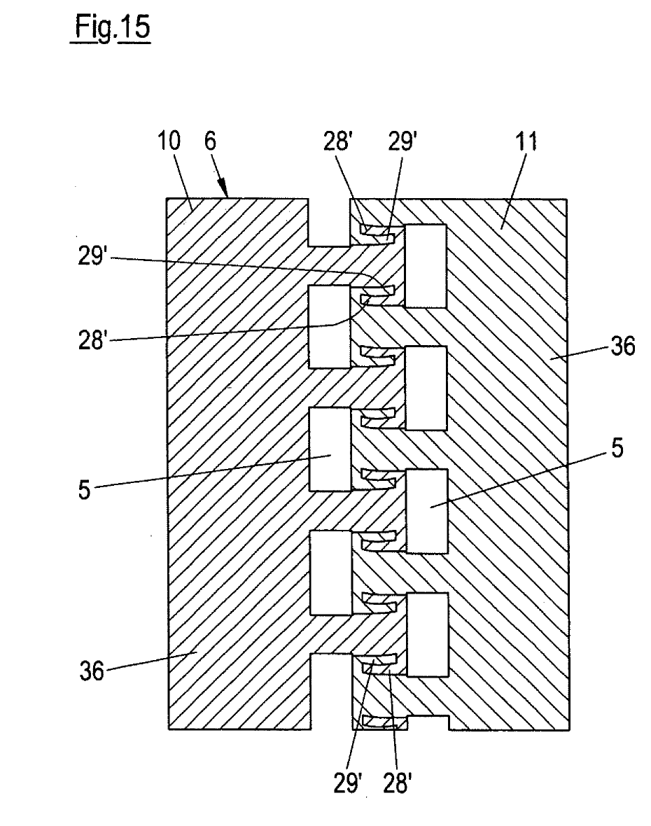

FIG. 15 a further view of the embodiment of FIGS. 2 to 7; and

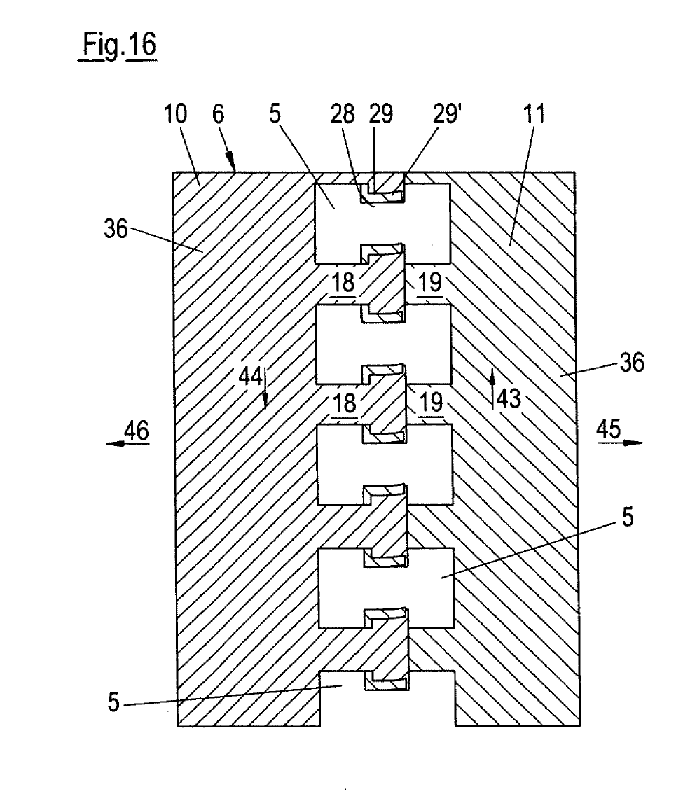

FIG. 16 a further embodiment of the invention.

FIG. 1 shows a section element 1 which is made as a C section. The section element 1 includes a section body 2 which has a section web 3 as well as two section limbs 4 laterally adjoining thereat which are each angled at a right angle to the section web 3. The free longitudinal edges of the section limbs 4 are in turn each angled by 90° to form the C section. The section element 1 in accordance with the invention can generally also be made, for example, as a U section, an L section, a T section, an H section, a hat section or a Z section.

A plurality of openings 5 are formed in the section web 3 which can serve, for example, as passage openings for cables or other elements to be laid.

The openings 5 of the section element 1 are manufactured without material loss in accordance with the invention, as will be explained in more detail in the following with reference to FIGS. 2 to 7.

FIG. 2 shows a material strip 6, for example a sheet metal strip, which serves as a starting material for the section body 2. Whereas in FIGS. 2 to 7, only one relatively narrow region of the material strip 6 is shown in each case which is ultimately used to form the section web 3, further material regions can in each case adjoin its outer edges 7, 8, with the section limbs 4, for example, being formed by said further material regions by corresponding bending over.

A meandering slit 9 which extends in the longitudinal extent of the material strip 6 and through which the material strip 6 and thus the section body 2 is divided into two separate longitudinal portions 10, 11 is formed in the material strip 6. The longitudinal portions 10, 11 are given respective meandering longitudinal edges 12, 13 by the meandering slit 9 which contact one another seamlessly in the representation in accordance with FIG. 2. The meandering longitudinal edges 12, 13 include edge portions which respectively extend in the longitudinal direction and extend perpendicular thereto, wherein edge portions 14 of the longitudinal edge 13 form undercuts with edge portions 15 of the longitudinal edge 13 in a direction transverse to the longitudinal extent of the material strip 6 and thus also of the section element 1.

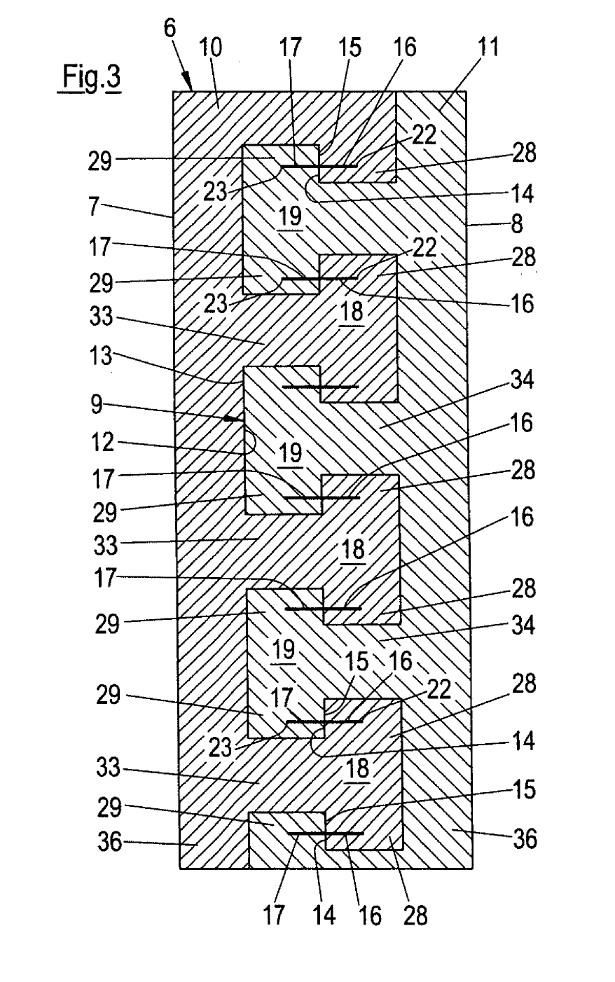

In accordance with FIG. 3, in addition to the meandering slit 9, slits 16, 17 are introduced into the longitudinal portions 10, 11 and respectively extend transverse to the longitudinal extent of the longitudinal portions 10, 11. The slits 16 in this respect extend, starting in each case from the undercut edges 14, into regions 28 of the longitudinal portion 10, whereas the slits 17 extend, starting in each case from the undercut edges 15, into regions 29 of the longitudinal portion 11. One respective slit 16 and one respective slit 17 are in this respect arranged so that they are aligned with one another.

Respective T-shaped portions 18, 19 of the longitudinal portions 10, 11 are formed by the meandering longitudinal edges 12, 13, with the parts of the crossbar of the T-shaped portions 18, 19 protruding in the longitudinal direction of the material strip 6 in each case forming the regions 28, 29 in which the slits 16, 17 are formed. The T-shaped portions 18, 19 furthermore include bar-shaped regions 33, 34 via which the crossbars of the T-shaped portions 18, 19 are connected to straight-line longitudinal strips 36 of the longitudinal portions 10, 11.

To produce the final shape of the section web 3, the undercut edge portions 14, 15 are initially each set upward or bent upward in the same direction from the plane of the material strip 6, as is shown in FIG. 4.

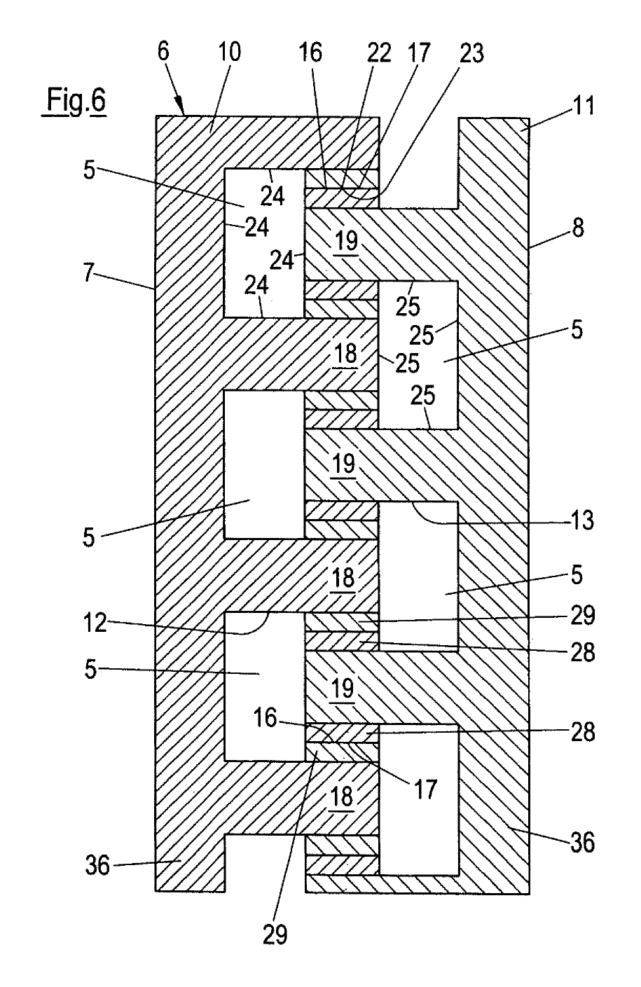

Subsequently, the two longitudinal portions 10, 11 are pulled apart in accordance with two arrows 20, 21 transverse to the longitudinal extent of the material strip 6, with the longitudinal portions 10, 11 being plugged into one another due to the aligned arrangement of the slits 16, 17 until the regions 28, 29 of the longitudinal portions 10, 11 overlap one another and the ends 22, 23 of the slits 16, 17 disposed within the portions 28, 29 come into contact with one another, whereby a further pulling apart of the longitudinal portions 10, 11 is prevented. The corresponding state with completely pulled apart longitudinal portions 10, 11 is shown in FIG. 6.

The openings 5 bounded by portions 24, 25 of the meandering longitudinal edges 12, 13 are simultaneously formed by the pulling apart of the longitudinal portions 10, 11 without material waste being produced.

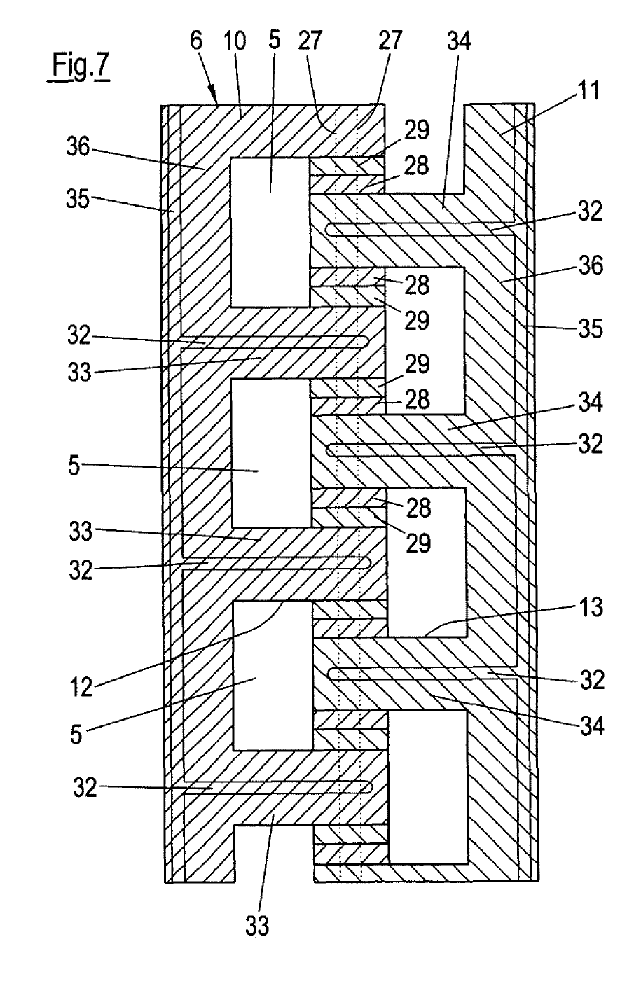

In addition to the plug-in connection of the longitudinal portions 10, 11, they can be connected to one another in accordance with FIG. 7 by further connection means such as welding seams 27. The welding seams 27 or other suitable connection means extend in this respect in particular also beyond the slits 16, 17 as well as beyond the overlapping regions 28, 29 of the longitudinal portions 10, 11.

As is indicated in FIG. 7, reinforcement beads 32 can be formed in the material portion 6. These reinforcement beads can in particular be formed in the web-shaped regions 33, 34 of the T-shaped portions 18, 19 and can extend transverse to the longitudinal extent of the material portion 6. Corresponding reinforcement beads 35, which extend in the longitudinal direction of the material portion 6, and which can in particular be connected to the reinforcement beads 32 can also be formed in the regions of the longitudinal edges 7, as is shown in FIG. 7.

The embodiment shown in FIGS. 8 to 10 only differs from the previously described embodiment in that, instead of the slits 16, 17, locking tabs 30 as well as locking openings 31 are formed in the regions 28, 29 of the longitudinal portions 10, 11.

The locking tabs 30 can in this respect, for example, be shaped directly from the portions 28, 29, as can in particular be recognized from FIG. 9. On the moving apart of the longitudinal portions 10, 11 transverse to their longitudinal extent, the free ends of the locking tabs 30 enter into the locking openings 31 until the end state shown in FIG. 10 is reached in which the locking tabs 30 project through the locking openings 31 and prevent a further mutual moving apart of the longitudinal portions 10, 11. To facilitate an introduction of the locking tabs 30 into the locking openings 31, the regions 28, 29 of the longitudinal portions 10, 11 containing the locking tabs 30 and the locking openings 31 can be bent out of the plane of the material strip 6 in opposite directions before the moving apart of the longitudinal portions 10, 11.

In the embodiment of FIG. 11, the connection means provided in the regions 29 are made as latching tabs 37. The latching tabs 37 are shaped out of the material of the longitudinal portion 11 in the regions 29 and have a run-on chamber 38 having a free end and also have a latching chamfer 39 adjoining thereto and connected to the longitudinal portion 11.

The connection means provided in the regions 28 are made as bridge-shaped tabs 40 which are formed out of the material of the longitudinal portion 10.

As can be recognized from FIG. 12, the latching tabs 37 pass through the bridge-shaped tabs 40 on the moving apart of the longitudinal portions 10, 11, whereby a latch connection of the longitudinal portions 10 and 11 is achieved.

Corresponding bridge-shaped tabs 40 can also be provided, for example, in the embodiment in accordance with FIGS. 8 to 10 instead of the tab openings 31. In this case, the bridge-shaped tabs 40 can extend downwardly in each case out of the material, starting from the regions 28, so that the locking tabs 30 can enter directly into the bridge-shaped tabs 40 on the moving apart of the longitudinal portions 10 and 11.

A further embodiment of the invention is shown in FIGS. 13 and 14 in which T-shaped portions are not formed by the meandering slit 9, but rather web -shaped portions 41, 42 which each protrude from the straight-line longitudinal strips 36 of the longitudinal portions 10, 11 and extend transverse to the longitudinal extent of the material portion 6. The web -shaped portions 41, 42 in this embodiment include the regions 28, 29 in which the connection means are provided, in the example as locking tabs 30 and locking openings 31. The connection means can generally also be made as latching tabs and as bridge-shaped tabs in this case, for example, or in any other suitable manner.

To bring the regions 28, 29 into overlap on the moving apart of the longitudinal portions 10, 11, in this embodiment, the longitudinal portions 10, 11 are first mutually displaced in the longitudinal direction in accordance with arrows 43, 44 until in each case a web -shaped section 41 overlaps a web -shaped portion 42. Subsequently, the longitudinal portions 10, 11 are moved apart in accordance with arrows 45, 46 until the locking tabs 30 engage into the locking openings 31, as is shown in FIG. 14. In contrast to the previously described embodiments, in this embodiment, the openings 5 are not alternately offset, but rather made lying directly behind one another in the longitudinal direction and have a large width, as can be recognized from FIG. 14.

It can be recognized from the representation of FIG. 15 that the setting upward of the regions 28, 29 can also take place before the moving apart of the longitudinal portions 10, 11 such that the outwardly disposed part regions 28′, 29′ arising by the slits 16, 17 are raised at their free ends so that the slits 16 17 are flared somewhat. In this manner, a secure plugging together of the longitudinal portions 10, 11 on the moving apart is ensured.

FIG. 16 shows an embodiment of the invention which is admittedly based on the section pattern shown in FIG. 2, i.e. the meandering slit 9 is made such that the T-shaped portions 18, 29 are produced.

To manufacture the section element 1, however, on the other hand, the longitudinal portions 10, 11 are first mutually displaced in the longitudinal direction, as described with regard to FIGS. 13 and 14, in accordance with the arrows 43, 44 until the web -shaped regions 33, 34 of the T-shaped portions 18, 19 lie on one another. Only in the next step are the longitudinal portions 10, 11 moved apart transverse to their longitudinal extent until they are plugged into one another by means of the slits 16, 17, as is shown in FIG. 16.

In this variant, the openings 5 which arise have enlarged dimensions with respect to the previously described embodiments, both in length and in the transverse direction.

The connection means in this variant, as in all other variants, can also not only be formed by slits, but also by the remaining described kinds of connection means.

In another respect, the embodiments in accordance with FIGS. 8 to 16 can include all the features described with respect to the embodiment of FIGS. 2 to 7. The longitudinal portions 10, 11 of these further embodiments can in particular also be connected to one another by additional connection means after the complete moving apart, as has already been described with respect to the first embodiment.

### REFERENCE NUMERAL LIST

1 section element
2 section body
3 section web
4 section limb
5 openings
6 material strip
7 outer edge
8 outer edge
9 meandering slit
10 longitudinal portion
11 longitudinal portion
12 meandering longitudinal edge
13 meandering longitudinal edge
14 edge portions
15 edge portions
16 slits
17 slits
18 T-shaped portions
19 T-shaped portions
20 arrow
21 arrow
22 end of the slit 16
23 end of the slit 17
24 portions of the meandering longitudinal edges 12, 13
25 portions of the meandering longitudinal edges 12, 13
27 weld seams
28 overlapping regions
28′ part region of 28
29 overlapping regions
29′ part region of 29
30 locking tabs
31 locking openings
32 reinforcement beads
33 web-shaped regions
34 web -shaped regions
35 reinforcement beads
36 longitudinal strip
37 latching tab
38 run-on chamfer
39 latch chamfer
40 bridge-shaped tabs
41 web-shaped portions
42 web-shaped portions
43 arrow
44 arrow
45 arrow
46 arrow

1.-16. (canceled)

17. A section element having an elongated section body (2) in which a plurality of openings (5) are formed,
wherein the section body (2) includes at least two separately formed longitudinal portions (10, 11);
with each longitudinal portion (10, 11) including a meandering longitudinal edge (12, 13); and
with the longitudinal portions (10, 11) having mutually overlapping regions (28, 29) which are regionally bounded by the meandering longitudinal edges (12, 13);
wherein connection means (16, 17; 30, 31; 37, 40) are formed in the overlapping regions (28, 29) via which the longitudinal portions (10, 11) are plugged together in a direction transverse to their longitudinal extent;
wherein the openings (5) are formed between portions (24, 25) of the meandering longitudinal edges (12, 13) of the two longitudinal portions (10, 11),
wherein slits (16, 17) extend, starting in each case from the meandering longitudinal edge (12, 13), into the overlapping regions (28, 29) of the longitudinal portions (10, 11) and extend transverse to the longitudinal extent of the respective longitudinal portion (10, 11); and wherein the longitudinal portions (10, 11) are plugged together by means of the slits (16, 17).

18. A section element in accordance with claim 17, wherein each longitudinal portion (10, 11) includes a plurality of portions (18, 19, 41, 42) which are bounded by the meandering longitudinal edges (12, 13) and protrude from a region of the respective longitudinal portion (10, 11).

19. A section element in accordance with claim 17, wherein the connection means are made as latch connection means (37, 40).

20. A section element in accordance with claim 17, wherein the longitudinal portions (10, 11) are connected to one another by further connection means (27) in addition to the plug-in connection via the connection means (16, 17; 30, 31, 37, 40).

21. A section element in accordance with claim 20, wherein the longitudinal portions (10, 11) are additionally connected to one another by a pressure joining process.

22. A section element having an elongated section body (2) in which a plurality of openings (5) are formed,
wherein the section body (2) includes at least two separately formed longitudinal portions (10, 11);
with each longitudinal portion (10, 11) including a meandering longitudinal edge (12, 13);
and with the longitudinal portions (10, 11) having mutually overlapping regions (28, 29) which are regionally bounded by the meandering longitudinal edges (12, 13);
wherein connection means (16, 17; 30, 31; 37, 40) are formed in the overlapping regions (28, 29) via which the longitudinal portions (10, 11) are plugged together in a direction transverse to their longitudinal extent;
wherein the openings (5) are formed between portions (24, 25) of the meandering longitudinal edges (12, 13) of the two longitudinal portions (10, 11), and
wherein locking tabs (30, 37) are formed in the overlapping regions (28, 29) of one or both longitudinal portions (10, 11) and project into locking openings (31, 40) formed in the overlapping regions (28, 29) of the respective other longitudinal portion (10, 11).

23. A section element in accordance with claim 22, wherein each longitudinal portion (10, 11) includes a plurality of portions (18, 19, 41, 42) which are bounded by the meandering longitudinal edges (12, 13) and protrude from a region of the respective longitudinal portion (10, 11).

24. A section element in accordance with claim 22, wherein the connection means are made as latch connection means (37, 40).

25. A section element in accordance with claim 22, wherein the longitudinal portions (10, 11) are connected to one another by further connection means (27) in addition to the plug-in connection via the connection means (16, 17; 30, 31, 37, 40).

26. A section element in accordance with claim 25, wherein the longitudinal portions (10, 11) are additionally connected to one another by a pressure joining process.

27. A method for manufacturing a section element having an elongated section body (2) in which a plurality of openings (5) are formed, comprising the steps of:
providing two separate longitudinal portions (10, 11) each having a meandering longitudinal edge (12, 13) to produce the section body (2), with the longitudinal portions (10, 11) having regions (28, 29) which are regionally bounded by the meandering longitudinal edges (12, 13);
forming connection means (16, 17; 30, 31, 37, 40) in the regions (28, 29) for the plugging together of the longitudinal portions (10, 11);
moving apart of the longitudinal portions (10, 11) transverse to their longitudinal extent such that the regions of the two longitudinal portions (10, 11) overlap, the longitudinal portions (10, 11) being plugged together via the connection means (16, 17; 30, 31, 37, 40); and the openings (5) being formed between portions (24, 25) of the meandering longitudinal edges (12, 13) of the two longitudinal portions (10, 11), and
forming slits (16, 17) for the production of the connection means which respectively extend from the meandering longitudinal edge (12, 13) into the regions (28, 29) of the longitudinal portions (10, 11) and extend transverse to the longitudinal extent of the respective longitudinal portion (10, 11).

28. A method in accordance with claim 27, further comprising the step of plugging together the longitudinal portions (10, 11) along the slits (16, 17).

29. A method in accordance with claim 27, further comprising the step of introducing at least one meandering slit (9), which extends in the longitudinal extent of the starting material (6) and by which the starting material (6) is divided into the two separate longitudinal portions (10, 11), into an elongated strip-shaped starting material (6).

30. A method in accordance with claim 27, wherein, during the step of moving apart of the longitudinal portions, the longitudinal portions (10, 11) are moved apart substantially perpendicular to their longitudinal extent.

31. A method in accordance with claim 27, further comprising the step of mutually displacing the longitudinal portions (10, 11) substantially in the longitudinal direction before the step of moving apart of the longitudinal portions (10, 11) transverse to their longitudinal extent.

32. A method in accordance with claim 27, further comprising the step of latching the longitudinal portions (10, 11) to one another.

33. A method in accordance with claim 27, wherein the regions (28, 29) of the longitudinal portions (10, 11) are set upward at least regionally before the moving apart.

34. A method in accordance with claim 27, further comprising the step of additionally connecting the longitudinal portions (10, 11) to one another by a pressure joining process after the moving apart.

35. A method in accordance with claim 27, wherein the method is configured for the manufacture of a section element (1) having an elongated section body (2) in which a plurality of openings (5) are formed,
wherein the section body (2) includes at least two separately formed longitudinal portions (10, 11);
with each longitudinal portion (10, 11) including a meandering longitudinal edge (12, 13); and
with the longitudinal portions (10, 11) having mutually overlapping regions (28, 29) which are regionally bounded by the meandering longitudinal edges (12, 13);
wherein connection means (16, 17; 30, 31; 37, 40) are formed in the overlapping regions (28, 29) via which the longitudinal portions (10, 11) are plugged together in a direction transverse to their longitudinal extent;
wherein the openings (5) are formed between portions (24, 25) of the meandering longitudinal edges (12, 13) of the two longitudinal portions (10, 11),
wherein slits (16, 17) extend, starting in each case from the meandering longitudinal edge (12, 13), into the overlapping regions (28, 29) of the longitudinal portions (10, 11) and extend transverse to the longitudinal extent of the respective longitudinal portion (10, 11); and wherein the longitudinal portions (10, 11) are plugged together by means of the slits (16, 17).

36. A method for manufacturing a section element having an elongated section body (2) in which a plurality of openings (5) are formed, the method comprising the steps of:
providing two separate longitudinal portions (10, 11) each having a meandering longitudinal edge (12, 13) to produce the section body (2), with the longitudinal portions (10, 11) having regions (28, 29) which are regionally bounded by the meandering longitudinal edges (12, 13);
forming connection means (16, 17; 30, 31, 37, 40) in the regions (28, 29) for the plugging together of the longitudinal portions (10, 11);
moving apart of the longitudinal portions (10, 11) transverse to their longitudinal extent such that the regions of the two longitudinal portions (10, 11) overlap, the longitudinal portions (10, 11) being plugged together via the connection means (16, 17; 30, 31, 37, 40); and the openings (5) being formed between portions (24, 25) of the meandering longitudinal edges (12, 13) of the two longitudinal portions (10, 11),
forming locking tabs (30, 37) and locking openings (31, 40) in the regions of the longitudinal portions (10, 11) to produce the connection means; and
engaging the locking tabs (30, 37) into the locking openings (31, 40) on the moving apart of the longitudinal sections (10, 11).

37. A method in accordance with claim 36, further comprising the step of plugging together of the longitudinal portions (10, 11) along the slits (16, 17).

38. A method in accordance with claim 36, further comprising the step of introducing at least one meandering slit (9), which extends in the longitudinal extent of the starting material (6) and by which the starting material (6) is divided into the two separate longitudinal portions (10, 11), into an elongated strip-shaped starting material (6).

39. A method in accordance with claim 36, wherein, during the step of moving apart of the longitudinal portions, the longitudinal portions (10, 11) are moved apart substantially perpendicular to their longitudinal extent.

40. A method in accordance with claim 36, further comprising the step of mutually displacing the longitudinal portions (10, 11) substantially in the longitudinal direction before the moving apart of the longitudinal portions (10, 11) transverse to their longitudinal extent.

41. A method in accordance with claim 36, further comprising the step of latching the longitudinal portions (10, 11) to one another.

42. A method in accordance with claim 36, wherein the regions (28, 29) of the longitudinal portions (10, 11) are set upward at least regionally before the moving apart.

43. A method in accordance with claim 36, further comprising the step of additionally connecting the longitudinal portions (10, 11) to one another after the moving apart.

44. A method in accordance with claim 36, wherein the method is configured for the manufacture of a section element (1) having an elongated section body (2) in which a plurality of openings (5) are formed,
wherein the section body (2) includes at least two separately formed longitudinal portions (10, 11);
with each longitudinal portion (10, 11) including a meandering longitudinal edge (12, 13);
and with the longitudinal portions (10, 11) having mutually overlapping regions (28, 29) which are regionally bounded by the meandering longitudinal edges (12, 13);
wherein connection means (16, 17; 30, 31; 37, 40) are formed in the overlapping regions (28, 29) via which the longitudinal portions (10, 11) are plugged together in a direction transverse to their longitudinal extent;
wherein the openings (5) are formed between portions (24, 25) of the meandering longitudinal edges (12, 13) of the two longitudinal portions (10, 11), and
wherein locking tabs (30, 37) are formed in the overlapping regions (28, 29) of one or both longitudinal portions (10, 11) and project into locking openings (31, 40) formed in the overlapping regions (28, 29) of the respective other longitudinal portion (10, 11).
